(19) United States
(12) Patent Application Publication
(10) Pub. No.: US 2023/0409663 A1
(43) Pub. Date: Dec. 21, 2023

(54) APPROACH FOR SENSITIVITY ANALYSIS OF ARBITRARY MULTI-PHYSICS SIMULATIONS USING AUTOMATIC DIFFERENTIATION

(71) Applicant: Luminary Cloud, Inc., Redwood City, CA (US)

(72) Inventors: Klaus Leppkes, Redwood City, CA (US); Michael Thomas Mara, La Jolla, CA (US); Juan José Alonso, Stanford, CA (US)

(21) Appl. No.: 18/212,116

(22) Filed: Jun. 20, 2023

Related U.S. Application Data
(60) Provisional application No. 63/354,148, filed on Jun. 21, 2022.

(51) Int. Cl. G06F 17/11

(52) U.S. Cl. CPC G06F 17/11

(57) ABSTRACT

An automatic differentiation (AD) technique and implementation processes multi-physics solver code entirely on graphics processing units (GPUs) to automatically differentiate one or more outputs of the code with respect to one or more inputs. The technique provides a “factory” framework that ingests arbitrarily complex solver code to produce a version of the code that is automatically differentiated (AD code) and mapped to the GPUs. The technique provides a derivative of the solver code output with respect to the inputs that enables analysis of the output of the computed solver code with initially provided inputs coherent with sensitivity analysis of that output as the inputs are changed. The adjoint information derived from solver code execution (AD code) computed by the AD technique may also be used to estimate one or more estimates of the numerical error in a solution to the physical simulation.

### CROSS-REFERENCE TO RELATED APPLICATIONS

The present application claims the benefit of U.S. Provisional patent application Ser. No. 63/354,148, which was filed on Jun. 21, 2022, by Klaus Leppkes et al. for APPROACH FOR SENSITIVITY ANALYSIS OF ARBITRARY MULTI-PHYSICS SIMULATIONS USING AUTOMATIC DIFFERENTIATION, which is hereby incorporated by reference.

### BACKGROUND

### Technical Field

The present disclosure relates to automatic differentiation and, more specifically, to automatic code differentiation of arbitrarily complex, multi-physics simulations or code.

### Background Information

Physics solvers are complicated physical simulation programs (simulation code) that generally represent transfer functions between inputs and outputs. The inputs may represent detailed geometry of a product being analyzed, operating conditions (e.g., speeds, pressures, angles of attack), and/or any of many boundary conditions supported by the simulation code. The outputs may be calculated from a solution of physical governing equations and may be used to represent physical quantities. The simulation code typically includes a sequence of arithmetic operations (calculations) for executing functions (e.g., manifested as lines of code) that accept one or more inputs and produce one or more outputs. Automatic differentiation (AD) is an approach that examines and differentiates a simulation code by applying differentiation techniques to each line of code in sequence using, e.g., the chain rule of differentiation, to effectively compute derivatives of the operations specified by the simulation code, automatically. The resulting derivatives or “sensitivities” (i.e., rate of change of an output of simulation code for a given set of input values) represent the variabilities of the outputs with respect to changes to the inputs. Illustratively, AD may apply to a situation where there are many inputs but only one output of interest, i.e., where the sensitivity analysis of only that output is desired. A typical methodology used to perform this type of AD is typically called the “adjoint” method or reverse mode of AD. AD may also apply to a situation where there are many outputs of interest but only one input; the methodology used in this situation is the “tangent” method or forward mode of AD.

A prior approach to performing AD involves source transformation, i.e., parsing and differentiating an initial simulation code (e.g., C++ code) to generate a new C++ code that can be optimized for running (execution) on specialized hardware accelerator resources, such as graphics processing units (GPUs). However, this approach is cumbersome and requires substantial input/output (I/O) activity as well as compilation and maintenance of the generated C++ code. Another previous approach involves calculating the operations of the initial simulation code on one or more general-purpose hardware processor resources, such as central processing units (CPUs), and recording information of those calculations in a sequential log fashion analogous to a “tape.” The tape is then processed to create the derivatives of the operations using the reverse mode of AD. This approach is also cumbersome, requires substantial I/O activity and does not adapt well to execution on GPUs.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a schematic block diagram of a virtualized computing environment;

FIG. 2 is a schematic block diagram of a virtual data center;

FIG. 3 is a schematic block diagram of an exemplary graphics processing unit; and

FIG. 4 is a schematic block diagram of an automatic differentiation factory framework environment including types of automatic differentiation codes.

### OVERVIEW

The embodiments described herein are directed to an automatic differentiation (AD) technique and implementation that processes (e.g., computes changes and sensitivities) multi-physics simulation software (e.g., solver code) entirely on specialized processing resources, e.g., graphics processing units (GPUs), to automatically differentiate one or more outputs of the code with respect to one or more inputs. To that end, the technique provides a context class or “factory” framework that ingests arbitrarily complex solver code to produce a version of the code that is automatically differentiated (AD code) and mapped (i.e., organized for efficient execution on GPU pipeline architectures) to the GPUs, i.e., the framework operates to automatically compute the derivatives of the solver code entirely on GPUs. The AD code effectively consists of simulation and differentiation kernels that are configured to run on the GPUs. Notably, the technique provides a derivative of the solver code output with respect to the inputs that enables analysis of the output of the computed solver code with initially provided inputs coherent with sensitivity analysis of that output as the inputs are changed. Note further that computation of Jacobian (transposed) vector (and Hessian tensor) products produced by the AD technique can be used directly for Newton-style optimization and also applies to higher-order differentiation.

In an embodiment, the adjoint information derived from solver code execution (AD code) computed by the AD technique may also be used to calculate one or more estimates of the numerical error (i.e., arising from a lack of mesh convergence) in a solution to the physical simulation. That is, the AD technique may be uniquely implemented to (i) obtain error estimates using the AD code and (ii) combine the estimates with adaptive mesh refinement (AMR) techniques that guide the adaptation of an initial mesh to accelerate solution convergence to a solution of known accuracy. Implementation of the AD technique described herein (i.e., with respect to automatic code differentiation for arbitrarily complex, multi-physics simulations executed on GPUs) further enables high performance computations, while reducing/obviating input/output (I/O) activity and significantly improving performance of the systems being simulated. Additionally, the AD technique has uses in the efficient generation of derivative-enhanced surrogate models, and even for efficient global sensitivity analysis.

The technique described herein improves upon prior approaches that operate entirely analytically through re-compilation of simulation code to generate a differentiated version of that code prior to applying to data. Essentially, the present technique improves the underlying computer functionality of specialized hardware computing resources (e.g., GPUs) to avoid unnecessary I/O activity and effectively utilize the hardware resources. As described herein, such improvements are directed to the use of computed results from a primary simulation to provide sensitivity analysis through execution of both AD and primary simulation in a manner that enhances the computation capability of a parallelized GPU environment.

### DESCRIPTION

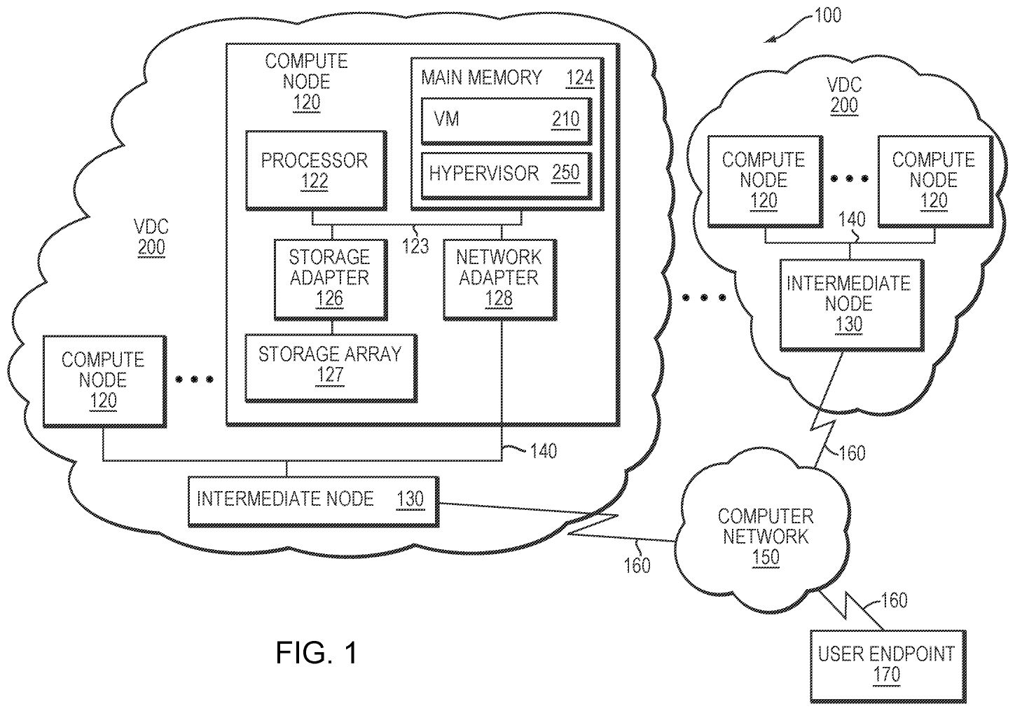

FIG. 1 is a schematic block diagram of a virtualized computing environment 100 that may be advantageously used with a factory framework disclosed herein. The virtualized computing environment includes one or more virtual data centers (VDCs 200) configured to provide virtualization that transforms physical hardware of the environment into virtual resources, as well as cloud computing that enables on-demand access to the virtualized resources, e.g., over a computer network. In an illustrative embodiment, the factory framework enhances the virtualization and cloud-computing capabilities of the VDCs 200 to provide seamless implementation of AD as well as improved execution of workloads, such as computer aided engineering (CAE) physical simulation software (e.g., solver code), as a cloud-based service offering, such as Software as a Service (SaaS), to users in a highly available, reliable, and cost-effective manner.

In an embodiment, the virtualized computing environment 100 includes one or more compute nodes 120 and intermediate nodes 130 illustratively embodied as one or more VDCs 200 interconnected by a computer network 150. The VDCs 200 may be cloud service providers (CSPs) deployed as private clouds or public clouds, such as deployments from Amazon Web Services (AWS), Google Compute Engine (GCE) of the Google Compute Project (GCP) ecosystem, Microsoft Azure, or VMWare. Each VDC 200 may be configured to provide virtualized resources, such as virtual storage, networking, memory, and/or processor resources that are accessible over the computer network 150, such as the Internet, to users at one or more user endpoints 170. Each compute node 120 is illustratively embodied as a computer system having one or more processors 122, a main memory 124, one or more storage adapters 126, and one or more network adapters 128 coupled by a network segment 123, such as a system interconnect. The storage adapter 126 may be configured to access information stored on magnetic/solid state storage devices, e.g., hard disk drives (HDDs), solid state drives (SDDs) or other similar media, of storage array 127. To that end, the storage adapter 126 may include input/output (I/O) interface circuitry that couples to the storage devices over an I/O interconnect arrangement, such as a conventional peripheral component interconnect (PCI), serial ATA (SATA), or non-volatile memory express (NVMe) topology.

The network adapter 128 connects the compute node 120 to other compute nodes 120 of the VDC 110 over local network segments 140 illustratively embodied as shared local area networks (LANs) or virtual LANs (VLANs). The network adapter 128 may thus be embodied as a network interface card (NIC) having the mechanical, electrical and signaling circuitry needed to connect the compute node 120 to the local network segments 140. The intermediate node 130 may be embodied as a network switch, router, or virtual private network (VPN) gateway that interconnects the LAN/VLAN local segments with remote network segments 160 illustratively embodied as point-to-point links, wide area networks (WANs), and/or VPNs implemented over a public network (such as the Internet). The VDC may utilize many different, heterogeneous network segments 123, 140, 160 for intra-node, inter-node, and inter-VDC communication, respectively, wherein the heterogeneous networks are diverse in characteristics such as bandwidth and latency. Communication over the network segments 140, 160 may be affected by exchanging discrete frames or packets of data according to pre-defined protocols, such as the Transmission Control Protocol/Internet Protocol (TCP/IP) and the OpenID Connect (OIDC) protocol, although other protocols, such as the User Datagram Protocol (UDP), the NVIDIA Collective Communications Library (NCCL), or the HyperText Transfer Protocol Secure (HTTPS) may also be advantageously employed.

The main memory 124 includes a plurality of memory locations addressable by the processor 122 and/or adapters for storing software code (e.g., processes and/or services) and data structures associated with the embodiments described herein. The processor and adapters may, in turn, include processing elements and/or circuitry configured to execute the software code, such as a virtual machine (VM) 210 and a hypervisor 250, and manipulate the data structures. The processors 122 may include general-purpose hardware processor resources, such as central processing units (CPUs) as well as specialized hardware accelerator resources, such as tensor processing units (TPUs) or, in an illustrative embodiment, graphics processing units (GPUs).

It will be apparent to those skilled in the art that other types of processing elements and memory, including various computer-readable media, may be used to store and execute program instructions pertaining to the embodiments described herein. Also, while the embodiments herein are described in terms of software code, processes, and computer, e.g., application, programs stored in memory, alternative embodiments also include the code, processes and programs being embodied as logic, components, and/or modules consisting of hardware, software, firmware, or combinations thereof.

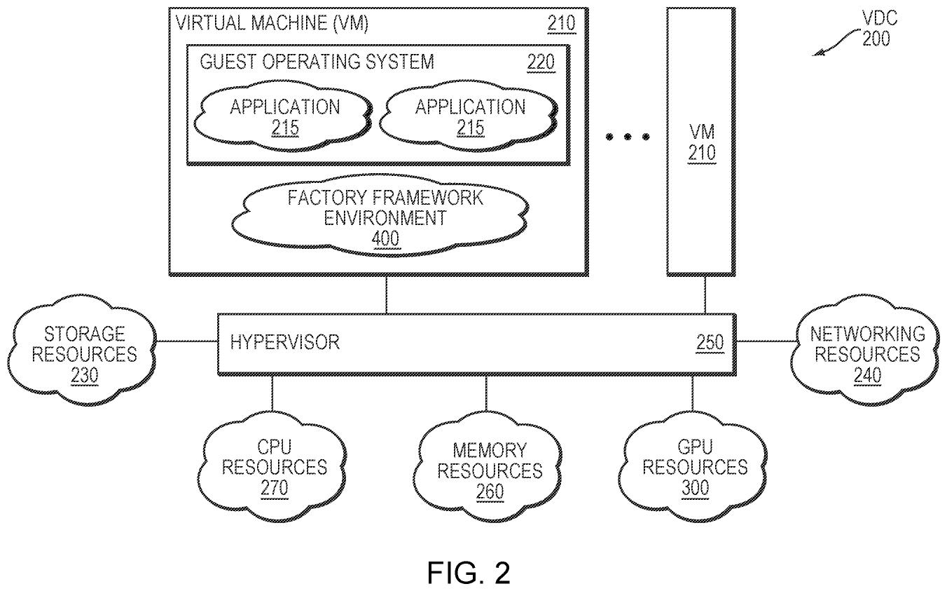

FIG. 2 is a schematic block diagram of a virtual data center (VDC) 200 including one or more virtual machines (VMs) 210. Each VM 210 is managed by a hardware abstraction layer, e.g., a hypervisor 250, which is a virtualization platform configured to mask low-level hardware operations from one or more guest operating systems executing in the VM 210. In an embodiment, the hypervisor 250 is illustratively the Xen hypervisor, although other types of hypervisors, such as the Hyper-V hypervisor and/or VMware ESXI hypervisor, may be used in accordance with the embodiments described herein. A guest operating system (OS) 220 and applications 215, such as physical simulation software (e.g., physics solver code), may run in the VM 210 and may be configured to utilize hardware resources of the VDC 200 that are virtualized by the hypervisor 250. The guest OS 220 may be the Linux operating system, FreeBSD and similar operating systems; however, it should be noted that other types of guest OSs, such as the Microsoft Windows operating system, may be used in accordance with the embodiments described herein. The guest OS 220 and applications 215 may cooperate with, at least in part, a factory framework environment 400 configured to extend the virtualization and cloud-computing capabilities of VDC 200, including the utilization of virtualized resources.

As noted, the virtualized resources of the virtualized computing environment include storage, networking, memory, and/or processor resources. In an embodiment, the VDC 200 may organize the resources as pools of virtualized resources. For example, the VDC 200 may organize the virtualized resources as pools of virtualized storage (e.g., HDD and/or SSD) resources 230, networking (e.g., NIC) resources 240, memory (e.g., random access memory) resources 260, and processor resources, such as pools of general-purpose processing resources and specialized processing resources. The pool of general-purpose processing resources may be embodied as a pool of CPUs 270 and the pool of specialized processing resources may be embodied as accelerators, such as TPUs or, illustratively, a pool of GPUs 300. These pools of resources may be organized and distributed among the compute nodes 120 of the VDC 200.

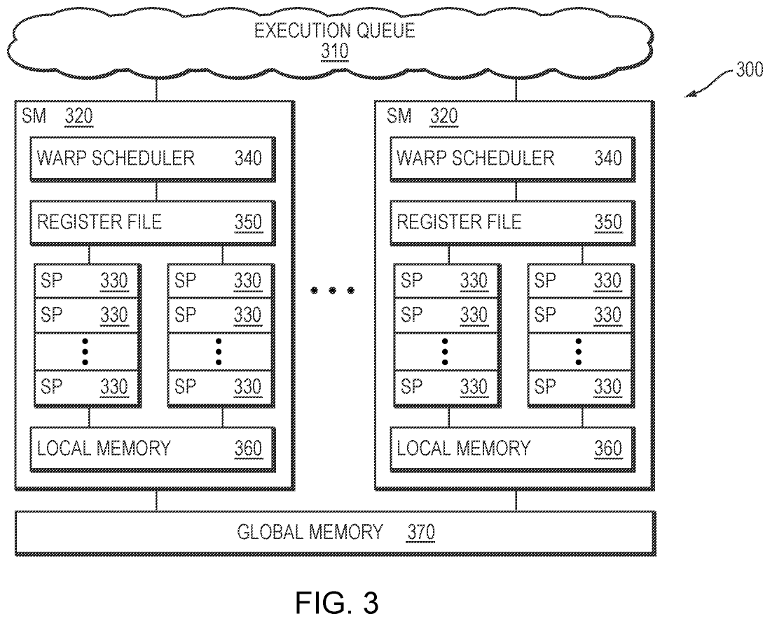

FIG. 3 is a schematic block diagram of an exemplary graphics processing unit (GPU) 300. Broadly stated, the GPU 300 is a computing device that includes a plurality of compute units, e.g., streaming multiprocessors (SMs) 320 configured to access a predetermined amount of global memory 370 at a predetermined memory bandwidth, e.g., 1.6 TB/s. Each SM 320 includes a plurality of streaming processors (SPs) 330 configured to execute instructions (e.g., of execution queue 310) from a group of threads, i.e., a warp. Every clock cycle, a warp scheduler 340 schedules a warp for execution on the SPs 330 of a SM 320. Analogously to CPUs hyperthreading, GPU 300 employs simultaneous multithreading (SMT) to schedule/execute multiple threads “at the same time.” In other words, when a thread is waiting for memory to compute, the GPU hardware can switch to a different thread so as to maximize computational throughput. It will be understood by persons of skill in the art that alternative GPU or accelerator architectures may be used that employ multiple cores arranged to perform pipeline operations, such as graphics pipelines, and generally may resemble dataflow machines organized as single instruction multi-data machines (SIMD) or multi-instruction multi-data machines (MIMD).

Each thread executing on a SP 330 can perform load/store data operations on (a) global memory 370 into/from register of register file 350 or (b) local memory 360 (which may likewise end up in the register file.) The bandwidth of memory accesses to/from the register file 350 is significantly faster than the GPU global memory access bandwidth. The significantly higher memory bandwidth allows the GPU 300 to achieve very high computational performance with computational kernels of the physics solvers configured to take advantage of the GPU hardware. Optimizing memory accesses in the GPU 300 is critical to obtaining performance as the performance of physics solvers and AD implementations are typically limited by memory bandwidth, not compute capacity of the GPU 300.

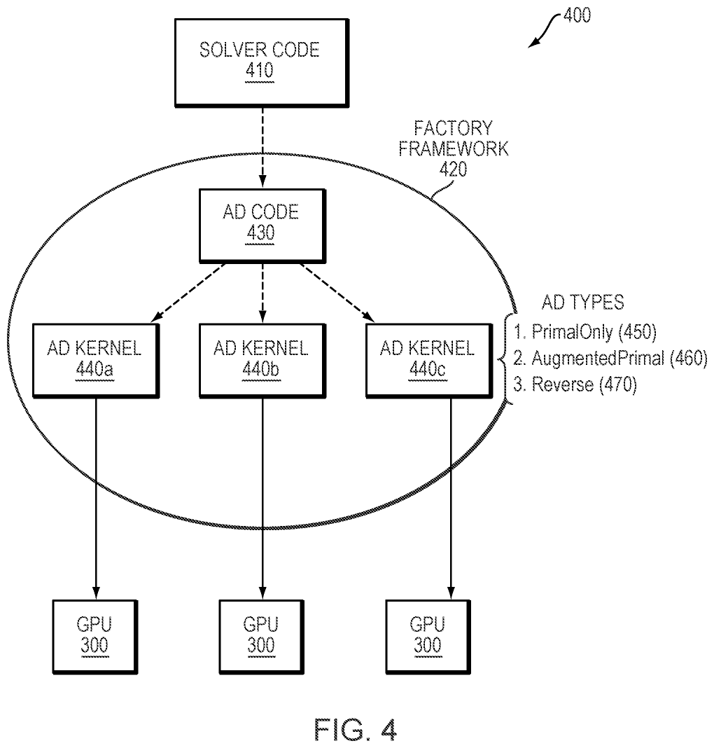

The embodiments described herein are directed to an automatic differentiation (AD) technique and implementation that processes (e.g., computes changes and sensitivities) multi-physics simulation software (e.g., solver code) entirely on specialized processing resources, e.g., GPUs, to automatically differentiate one or more outputs of the code with respect to one or more inputs. To that end, an automatic differentiation (AD) factory framework environment 400 generates different types of AD codes, as shown in the schematic block diagram of FIG. 4. Illustratively, the AD technique provides a context class or AD “factory” framework 420 that ingests arbitrarily complex solver code 410 to produce a version of the code that is automatically differentiated (AD code 430) and mapped (i.e., organized for efficient execution on GPU pipeline architectures) to the GPUs 300 as AD kernels 440a-c, i.e., the framework operates to automatically compute the derivatives of the solver code entirely on GPUs. Notably, the AD code 430 may be partitioned into simulation and differentiation kernels 440a-c that are configured to run on the GPUs 300 concurrently. Further, the technique provides a derivative of the solver code outputs with respect to the inputs that enables analysis of the outputs of the computed solver code with initially provided inputs coherent with sensitivity analysis per output as the inputs are changed. In an embodiment, the same factory framework may be used to compose derivative operations to obtain not just first-derivative information but also higher-order derivatives computed with the combination of tangent and adjoint modes of sensitivity calculation.

### AD Factory Framework

The AD factory framework may be described as providing domain-specific language (DSL) for AD kernels. That is, the factory framework may implement a language for efficiently expressing domain-specific semantic and syntactic constructs for greater efficiency. In an embodiment, a kernel 440 implements code for a (virtual) thread and represents a useful amount of computation, e.g., load a set of inputs, compute some values and store the results back into global memory 370. Complex workflows (such as physics solvers and AD code) may require a large number of kernels (fluxes, boundary conditions, matrix operations, solution updates, etc.) to carry out necessary operations. Such kernels are vectorized and parallelized by a compiler. However, note that for GPU architectures, vectorization is of fundamental importance, as the implicit vector size is usually fixed, e.g., 32, which may be implemented as a set of threads called a “warp”. As will be understood by persons of skill in the art, different GPU architectures may incur differing features and limitations which may be incorporated into expressions of the DSL or semantic processing of the DSL in generating the AD kernels 440.

Automatic (or algorithmic) differentiation is a technique to calculate first- and higher-order derivatives of functions implemented as code (e.g., C++ code, although the same concepts may be applied to other programming languages.) Two modes and their combinations are employed: tangent mode (analogous to using Finite Differencing to compute derivatives) mostly computes products of Jacobian matrices (sparse) times vectors; and adjoint mode computes products of the transpose of the Jacobian matrix (also sparse) and vectors. For example, consider a code implementing a function (F: Rⁿ→R^{m}) with n inputs and m outputs. The Jacobian Matrix can be computed by using the identity vectors, yielding a (naive) cost for computing the Jacobian Matrix of O(n) for the tangent mode and O(m) for the adjoint mode. For a small number of outputs (e.g., m=1) the adjoint mode may yield a full gradient with n components in constant time and complexity. The AD technique described herein implements both tangent and adjoint modes, and switches automatically between one and the other depending on which approach is more efficient based on the relative number of inputs/outputs as requested by a user—whether m<n or m>n and associated compute costs. The AD technique described herein is also able to compose tangent and adjoint modes to produce higher-order derivatives with minimum computational effort and without the need for additional programming.

Dataflow of tangent computations is identical to that of a primal computation (i.e., the solution of the original physics problem). However, for adjoint mode computation a data flow reversal problem exists: the adjoint of an input becomes an output and the adjoint of an output becomes an input. For forward dataflow computations, read races are permitted and may even be desirable as they yield better performance as a result of cache hits. Adjoint computations reverse the direction of the dataflow, transforming shared reads of inputs into shared writes (usually increments) for the input adjoints. Because of these requirements, a naive solution approach is to use atomic operations for the input adjoint updates to avoid erroneous results and/or race conditions. However, performance degrades as contention (i.e., collisions) increases, e.g., a number of concurrent requests to update a particular variable/datum. In a worst-case scenario, where those threads that atomically read (i.e., AtomicAdd operation) the same value of a variable/parameter, every thread launched increases a number of collisions equal to the total number of threads. To optimize performance, the technique executes primal and adjoint solvers concurrently and spawns as many threads as possible to saturate the compute capability of the GPU(s). The idea is that the Kernel code stays the same and simply can be instantiated with arbitrary types, enabling performance of different (first and higher order) AD modes. In this manner, the Kernel code for each type can be improved for optimal performance on the GPUs.

In an embodiment, kernels for adjoint mode computations consist of three AD types or modes:
1. PrimalOnly 450, wherein forward values (having a type of float or double and also including tangent and Taylor types) for the next kernels are computed.
2. AugmentedPrimal 460, wherein additional information to reverse data flow is stored (if needed).

For all forward types (float, double, tangent), the kernel only needs to be invoked once that kernel may be called using different AD types. For simplicity, fundamental data types such as float/double are considered as zero-order AD types, as they only contain primal state (or Output) information (y). Notably, computing the product of the local partial derivative and the output adjoint vector is normally achieved by adjoining sections of the code, for which calculating local partial derivatives in reverse order is needed. To avoid the computational cost of a recompute-all scheme or the memory cost of a store-all scheme, the AD technique exploits identities that can be optimized for memory and computational cost to calculate local derivatives or even the entire J^{T}. v (e.g., linear solvers). Notably, the augmented primal step stores additional information as part of the third type or mode as follows to facilitate reverse data flows.
3. Reverse 470, wherein the actual J^{T}·v is calculated and any information stored during step 2 (AugmentedPrimal) is read. Notably, this is a dataflow reversal such that the adjoint of an input is an output and the adjoint of an output is an input. The input adjoint (if the partial is non-zero) is incremented or written during this operation.

Illustratively, the above types may be applied to a differentiable function, y=F(x), as follows:

First-order Tangent types contain primals as a Jacobian times vector product: (y,yₜ)=F(x,xₜ), where y=F(x) and yₜ=F′(x)·xₜ.

First-order Adjoint types contain primal+Jacobian transposed vector product information. (y,xₐ)=F(x,yₐ), where y=F(x) and xₐ=F′(x)^{T}·yₐ. Of course, multiple directions can be computed via a tangent or adjoint vector mode type, e.g., a first-order tangent vector type (where k denotes a vector size) contains the scalar primal information, and k Jacobian times v₁, . . . ,vₖ vector products:

(y,y1ₜ₁, . . . yₜₖ)=f(x,xₜ₁, . . . xₜₖ).

Same Holds for Vector Adjoint Types:

(y,x_a₁, . . . aₐₖ)=f(x,y_a₁, . . . yₐₖ).

Further, type chaining allows higher-order tangent over tangent or tangent-over-adjoint types in scalar or vector fashion up to arbitrary orders. In addition to tangent and adjoint types, Taylor arithmetic types may be used to compute an arbitrary-order derivative tensor.

Note that higher-order derivatives can be reconstructed by computing independent rays such that computation of the rays may occur in parallel (i.e., components of the sum in the following formula may be run independently):

$${f}_{i} ( x ) = {\sum }_{\vert j \vert = d} {f}^{( \vert i \vert )} ( x ; Sj ) {\underbrace{\begin{matrix}{\sum }_{0 < k \leq i} & {( - 1 )}^{\vert i - k \vert} ( \begin{matrix}i \\ k\end{matrix} ) ( \begin{matrix}dk / \vert k \vert \\ j\end{matrix} ) {( \frac{\vert k \vert}{d} )}^{\vert i \vert}\end{matrix}}}_{≡ {c}_{i , j}}$$

where S in R^{(n×n)} denotes a coordinate transformation matrix resulting from

f(h):=f(x+h S i) with i in Nⁿ being a multi index.

In general, the overall complexity for n inputs to compute all derivative tensors up to order d is:

$$q ( d , n ) = \frac{( d + 2 ) ( d + 1 )}{{2}^{d + 1}} + ( \frac{1}{n} )$$

Whereas the tangent over adjoint yields better complexity (i.e., O(n)) for a scalar objective function, for higher orders, a Taylor ray approach yields lower computational costs as indicated below:

$$- d = 2 ⇒ q ( n ) = 1.5 + ( \frac{1}{n} )$$

$$- d = 3 ⇒ q ( n ) = 1.25 + ( \frac{1}{n} )$$

$$- d = 4 ⇒ q ( n ) = 1 + ( \frac{1}{n} )$$

$$- d = 5 ⇒ q ( n ) = 0.65625 + ( \frac{1}{n} )$$

$$- d = 6 ⇒ q ( n ) = 0.4375 + ( \frac{1}{n} )$$

$$- d = 10 ⇒ q ( n ) = 0.0644531 + ( \frac{1}{n} )$$

Note that similarly to the tangent and adjoint mode, Taylor types may be used to play the same trick for m outputs by using a Taylor forward type inside an adjoint type, essentially reducing the dominant complexity. Further, interpolation coefficient groups may be exploited to exploit zero coefficients.

To address the dataflow reversal, the AD technique applies a factory pattern for the outputs and annotates how the input adjoints are updated in global memory 370. Illustratively, a warp shuffle instruction is used to perform a butterfly reduction, thus drastically reducing the amount of (final) atomic operations added and therefore improving performance.

Other variables are analyzed to determine whether they are only read by one thread so that an adjoint update is simply added (e.g., “+=” operator) back into global memory 370. For variables read by more than one thread, atomic operations are added. Notably, this applies only to primal data types such as “float” or “double.”

For adjoint types, creating an output adjoint will return an adjoint data structure with corresponding adjoint values and zero-initialized primal value components. For PrimalOnly output creation, a zero-initialized double or tangent type object is returned. Beside zero (float, double) or first order (tangent or adjoint) types, kernels 440 with tangent over tangent or tangent over adjoint variable types may be instantiated, which allows for computation of arbitrary products of a Hessian tensor and vectors (i.e., m==1, in general Hessian tensor products or a matrix for scalar output) for second order from a same kernel (code).

For faster convergence the primal solution converges first, i.e., normal performance of the computational fluid dynamics (CFD) primal solver. From that converged solution, the Solver in Tangent (scalar or vector mode) executes and only converges the tangent component as far as necessary. In this manner, a significant reduction of computational costs is achieved without a need to start from an unconverged solution. Note that tangent solver iterations are 2-3× the runtime costs of the primal only types (i.e., float or double), e.g., a CFD simulation may take 10,000 iterations to converge. Illustratively, consider a time to compute the primal solution is to. Then using full tangent mode, the costs/time are R_tangent (e.g., 3)·t₀. Assuming that only 2,000 iterations are needed to converge the tangents, the overall costs may be determined as: t₀+2000/10000(0.2)·R_tangent(3)·t₀=t₀+0.2·3·t₀=1.6*t₀ versus 3·t₀ for a naive tangent mode from the start).

### Numerical Error Estimation

In an embodiment, the adjoint information derived from solver code execution (AD code) computed by the AD technique may also be used to calculate one or more estimates of the numerical error (i.e., arising from a lack of mesh convergence) in a solution to the physical simulation. That is, the AD technique may be uniquely implemented to (i) obtain error estimates using the AD code and (ii) combine the estimates with adaptive mesh refinement (AMR) techniques that guide the adaptation of an initial mesh to accelerate solution convergence to a solution of known accuracy. Implementation of the AD technique described herein (i.e., with respect to automatic code differentiation for arbitrarily complex, multi-physics simulations executed on GPUs) further enables high performance computations, while reducing/obviating I/O activity (e.g., transferring information from the GPU pipeline to the CPU or storing information to permanent storage) and significantly improving performance of the systems being simulated. Additionally, the AD technique has uses in the efficient generation of derivative-enhanced surrogate models, and even for efficient global sensitivity analysis.

Illustratively, the sensitivity/derivative information computed using the AD technique for multi-physics simulations may be leveraged in an integrated fashion (i.e., fully integrated with the factory framework, without resorting to the use of I/O and without ever writing the physical and sensitivity solutions to permanent storage) to estimate numerical errors in the solution of a multi-physics problem and to control/reduce those errors below a user-specified threshold to automatically provide users with reliable and trusted solution information, automatically. Numerical error estimation is based upon computing a correction to a given baseline solution that more closely approximates the exact solution, so that the difference between the baseline and corrected solutions can be used to provide an estimate of the error.

### Adjoint-Based Methods for Numerical Error Estimation

The AD factory framework 420 can efficiently (fully and natively on GPUs 300 of data centers, such as VDCs 200) compute derivatives/sensitivities of output quantities (lift, drag, moment, but also residuals) with respect to any input quantity representing the shape of the design/object and any of the operating conditions. These sensitivities can be leveraged to estimate numerical errors and, if the sensitivities are computationally inexpensive, native to GPU, and readily available (without the need to use permanent storage), this information can be used for numerical error estimation and to drive AMR processes to improve (further refine) meshes that result in a level of numerical error requested by a user while reducing further computational burden.

For example, consider the solution of an arbitrary multi-physics problem described as Rₕ (Uₕ)=0, a large set of coupled non-linear equations (the residuals Rₕ at every element of the mesh), wherein h represents the average size of a mesh element. Illustratively, for every equation in a typical multi-physics problem, such as for a Reynolds-Averaged Navier-Stokes (RANS) CFD solution on a mesh with 300M elements that solves for a typical 7 quantities in each element (density, 3 velocities, pressure, and 2 turbulence quantities), there are about 2.1 billion Rₕ s that depend on the solution and that need to be zeroed out, which multi-physics solvers (and, more specifically, CFD solvers) perform very efficiently. Applying this to simulate, e.g., lift or drag of an aircraft by computing Jₕ(Uₕ), a small perturbation in any of the 2.1 B residuals δ Rₕ(Uₕ) results in a corresponding small perturbation of the output δ Jₕ(Uₕ) that may be given by the following equation:

δJₕ(Uₕ)=ψ^{T}ₕ·δRₕ(Uₕ)

where ψ^{T}ₕ is the transpose of the adjoint vector ψₕ of the solution of the multi-physics problem for this output functional Jₕ(Uₕ). Notably, ψ^{T}ₕ is the adjoint solution calculated by factory framework 420. That is, changes in the desired output function may be calculated from the residuals multiplied by the transpose of the solution to the multi-physics problem without further computation.

This technique may be further refined to compute the output of a solution on a hypothetical fine mesh with very low (or zero) numerical error and a small mesh (grid) spacing h (i.e., computing Jₕ(Uₕ)), but due to computational cost (the mesh would otherwise be too fine) the simulation may be computed on a coarser mesh, with mesh spacing H, with H>h. With the simulation on the coarser mesh, a less accurate approximation is computed to the output, J_{H}(U_{H}). Illustratively, the error estimation method may be used to estimate the error in J_{H}(U_{H}) and achieve the effect of having applied the very fine grid space h so as to obtain Jₕ(Uₕ). Adjoint-weighted residual methods lead to the following formula for the error in the J_{H}(U_{H}) approximation:

$${J}_{H} ( {u}_{H} ) - {J}_{h} ( {u}_{h} ) = {\underbrace{\begin{matrix}- & {( {ψ}_{h}^{H , mv} )}^{T} {R}_{h} ( {u}_{h}^{H} )\end{matrix}}}_{computable correction} {\underbrace{\begin{matrix}+ ( {δψ}_{h}^{mv} & {)}^{T} {R}_{h} ( {u}_{h}^{H} )\end{matrix}}}_{remaining error}$$

The error (left hand side of the expression) is related to the following (from left to right on the RHS of the equation):
1. The adjoint solution computed using the coarse mesh, H, and interpolated to the fine mesh;
2. The residual on the fine mesh, h, computed by interpolating the coarse solution U_{H} onto the fine mesh, h;
3. A correction for the prolongated coarse adjoint, and
4. The same residual as above in element #2

The first two (1 and 2), taken together, are called the computable correction, because both components can be computed using the solution and adjoint solution on the coarse mesh, H. The second term is the remaining error, which is more effective as a mesh adaption indicator, but would require the calculation of the solution and adjoint solution in the fine mesh, h, which is prohibitively computationally expensive. For this reason, element #3 above is approximated in the remaining error and the solution via (i) direct injection and approximation of the coarse solutions into the fine mesh (illustratively with some quadratic reconstruction), or (ii) injecting the coarse solution and adjoint solution into the fine mesh and performing a partially converged (and therefore less expensive) solution with just a few iterations in the finer mesh.

### Non-Linear Correction Methods for Numerical Error Estimation

An alternative approach to estimate numerical errors in simulations is to compute the residual on a finer version of the mesh that can be used as a source term on the original mesh to drive the solution closer to the (unknown) exact solution. That is, starting from the initial converged solution U_{H}, iterate N additional iterations of the solver with the residual on the finer grid Rₕ applied as a source term until obtaining the corrected solution U*:

R_{H}(U*)=Rₕ(L(U_{H}))

where L(U_{H}) is a linear interpolation onto the finer mesh h. Another alternative is to use polynomial refinement (‘P-refinement’) instead of H-refinement to increase the order of accuracy within the grids cells while keeping cell geometry fixed.

### Adjoint-Based Error Estimation to Guide AMR

In an embodiment, the adjoint-weighted residual method may be used to both estimate numerical errors in multi-physics solutions and to guide AMR techniques to adapt the meshes in those simulations to arrive at final solutions with numerical errors below a user-specified tolerance. This method also allows the ability to specify numerical error bars on the outputs of the simulations to inform the user of the numerical quality of the outputs of the simulations that may be used to form the basis of design decisions and to assess whether the accuracy is sufficient or not. Notably, the AD adjoint calculation and the error estimation are carried out simultaneously using in-memory data structures to improve integration and performance of the overall AMR techniques, so as to appear seamless in all simulations. The following pseudo-code illustrates the process:
1. Generate an initial coarse mesh (nominally with mesh (grid) spacing H) that conforms to the geometry in question;
2. Compute a (potentially partially converged) solution using the mesh with spacing H, U_{H}, and extract the output of interest, J_{H}(U_{H}), which has significant numerical error;
3. Simultaneously, compute an adjoint solution for the output functional of interest, ψ_{H};
4. Interpolate both the current solution, U_{H}, and the adjoint solution, ψ_{H}, onto a finer mesh with mesh spacing h using any of a variety of projection methods (e.g., higher-order polynomials, direct injection, etc.) to create Uₕ^{H} and ψ^{h}_{H};
5. Compute the fine-grid residual using the interpolated solution, Rₕ(Uₕ^{H});
6. Estimate the adjoint correction, δψₕ, using similar interpolation methods as in step #4;
7. Estimate both the computable correction and the remaining error according to the above-indicated formula to (a) understand an amount of numerical error in the solution, and, if needed, (b) compute AMR indicators to refine the mesh, and
8. If the error is below the user-specified threshold, EXIT the process;
9. If the error is not below the user-specified threshold, adapt the mesh using the computed AMR indicators and GO TO Step #2, where the refined mesh (via AMR) becomes the new H.

Notably, the adjoint calculation is carried out using factory framework 420 with the same (and some additional) data structures as the main multi-physics simulation. Therefore, no I/O (i.e., transfer of information from persistent storage or from the CPU) is required for calculation of computable corrections, remaining errors, and AMR indicators, thus improving performance over typical implementations in research codes. In addition, every step in the pseudo-code above is carried out in GPU except, possibly, Steps #1 and #8, and #9. Steps #1 and #9 can be executed simultaneously (concurrently) on the CPU and GPU.

### AD-Tangent-Based Linearized Error Estimation

In another embodiment, a non-linear correction approach for error estimation may be used that generally does not require the use of AD sensitivities, but may require that, after a solution on a coarse mesh, U_{H}, is computed, a right-hand-side source term to the original governing equations is computed which is used for an additional set of iterations to compute an improved solution (and therefore an error estimate) U*, according to the following equation (presented earlier):

R_{H}(U*)=Rₕ(L(U_{H}))

A linear correction to the coarse-mesh solution U_{H} can be computed using a linearization of the governing equation above that can be computed using the AD-tangent mode approach described herein. The following pseudo-code illustrates the process:
1. Generate an initial coarse mesh (nominally with mesh (grid) spacing H) that conforms to the geometry in question;
2. Compute a (potentially partially converged) solution using the mesh with spacing H, U_{H}, and extract the output of interest, J_{H}(U_{H}) which has significant numerical error;
3. Interpolate the current solution, U_{H}, onto a finer mesh with mesh spacing h using any of a variety of projection methods (e.g., higher-order polynomials, direct injection, etc.) to create L(U_{H});
4. Compute the fine-grid residual using the interpolated solution, Rₕ(L(U_{H}));
5. Compute an AD-tangent solution (i.e., a linearization) for the modified governing equations using the primal solution;
6. Estimate a linearized error correction to (a) understand the amount of numerical error in the solution, and, if needed, (b) compute AMR indicators to refine the mesh;
7. If the error is below the user-specified threshold, EXIT the process;
8. If the error is not below the user-specified threshold, adapt the mesh using the computed AMR indicators and GO TO Step #2, where the refined mesh (via AMR) becomes the new H.

As above, the tangent calculation is carried out using the AD factory framework 420 with the same (and some additional) data structures as the main multi-physics simulation. Therefore, no I/O is required for calculation of computable corrections, remaining errors, and AMR indicators, thus improving performance over typical implementations in research codes. Moreover, every step in the pseudo-code above is carried out in GPU except, possibly, Step #1 and #7 and #8. Steps #1 and #8, can be done simultaneously on CPU and GPU.

The foregoing description has been directed to specific embodiments. It will be apparent however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A non-transitory computer readable medium including program instructions for execution on hardware resources, the program instructions configured to:
ingest a physical simulation solver into an automatic differentiation (AD) framework running on the hardware resources provided by a data center;
generate a version of the physical simulation solver that is automatically differentiated (AD code);
organize the AD code for execution on specialized accelerator resources (accelerators) provided by the data center according to simulation and differentiation kernels configured for concurrent execution on pipeline architectures of the accelerators such that derivative information computed using the pipeline architecture is integrated between the simulation and differentiation kernels without input/output (I/O) operations outside the accelerator pipeline architecture to other of the hardware resources or to permanent storage; and
estimate one or more numerical errors in a solution to the physical simulation solver without the I/O operations using computed derivative information from the concurrent AD code execution to converge the solution to the physical simulation solver to below a user-specified threshold.

2. The non-transitory computer readable medium of claim 1, wherein the estimated numerical error is combined with mesh refinement to accelerate solution convergence of the physical simulation solver to below the user-specified threshold.

3. The non-transitory computer readable medium of claim 1, wherein the AD code execution computes the derivative information by switching between calculating adjoint information and tangent information in the solution to the physical simulation solver depending on a relative number of inputs versus outputs as requested by a user.

4. The non-transitory computer readable medium of claim 3, wherein the adjoint information computation is partitioned into one or more of (i) a kernel for forwarding computed values to a next kernel or (ii) a kernel for reversing flow of computed values such that an adjoint of an input is an output and the adjoint of another output is another input.

5. The non-transitory computer readable medium of claim 4, wherein the adjoint information computation is partitioned into one or more additional kernels that store intermediate information to support the kernel for reversing the flow of computed values.

6. The non-transitory computer readable medium of claim 3, wherein the tangent information is used to compute a linearized solution and a linearized error correction to estimate the one or more numerical errors in the solution.

7. The non-transitory computer readable medium of claim 1, wherein the organization of the AD code partitions primal and adjoint solvers for concurrent execution and spawns a number of threads to saturate a compute capability of the accelerators.

8. The non-transitory computer readable medium of claim 1, wherein the estimated one or more numerical errors is calculated from an adjoint solution computed on a coarse mesh and interpolated on a finer coarser specified by the user for the physical simulation solver.

9. The non-transitory computer readable medium of claim 8, wherein the estimated one or more numerical errors includes calculating a remaining error via one of (i) direct injection and approximation of solutions for the coarser mesh into the user specified mesh, or (ii) injecting the solutions for the coarser mesh and the computed adjoint into the user specified mesh and performing a partially converged solution.

10. The non-transitory computer readable medium of claim 1, wherein the program instructions for execution on the hardware resources further includes program instructions to:
in response to the estimated numerical error being greater than the user-specified threshold, adaptively refine a current mesh of the physical simulation solver and continue execution of the physical simulation solver.

11. A method for executing a physical simulation solver comprising:
ingesting the physical simulation solver at an automatic differentiation (AD) framework running on hardware resources provided by a data center;
generating a version of the physical simulation solver that is automatically differentiated (AD code);
organizing the AD code for execution on specialized accelerator resources (accelerators) provided by the data center according to simulation and differentiation kernels configured for concurrent execution on pipeline architectures of the accelerators such that derivative information computed using the pipeline architecture is integrated between the simulation and differentiation kernels without input/output (I/O) operations outside the pipeline accelerator architecture to other of the hardware resources or to permanent storage; and
estimating one or more numerical errors in a solution to the physical simulation solver without the I/O operations using computed derivative information from the concurrent AD code execution to converge the solution to the physical simulation solver to below a user-specified threshold.

12. The method of claim 11, wherein the estimated numerical error is combined with mesh refinement to accelerate solution convergence of the physical simulation solver to below the user-specified threshold.

13. The method of claim 11, wherein the AD code execution computes the derivative information by switching between calculating adjoint information and tangent information in the solution to the physical simulation solver depending on a relative number of inputs versus outputs as requested by a user.

14. The method of claim 13, wherein the adjoint information computation is partitioned into one or more of (i) a kernel for forwarding computed values to a next kernel or (ii) a kernel for reversing flow of computed values such that an adjoint of an input is an output and the adjoint of another output is another input.

15. The method of claim 14, wherein the adjoint information computation is partitioned into one or more additional kernels that store intermediate information to support the kernel for reversing the flow of computed values.

16. The method of claim 13, wherein the tangent information is used to compute a linearized solution and a linearized error correction to estimate the one or more numerical errors in the solution.

17. The method of claim 11, wherein the organization of the AD code partitions primal and adjoint solvers for concurrent execution and spawns a number of threads to saturate a compute capability of the accelerators.

18. The method of claim 11, wherein the estimated one or more numerical errors is calculated from an adjoint solution computed on a coarse mesh and interpolated to a finer mesh specified by the user for the physical simulation solver.

19. The method of claim 18, wherein the estimated one or more numerical errors includes calculating a remaining error via one of (i) direct injection and approximation of solutions for the coarser mesh into the user specified mesh, or (ii) injecting the solutions for the coarser mesh and the computed adjoint into the user specified mesh and performing a partially converged solution.

20. The method of claim 11 further comprising:
in response to the estimated numerical error being greater than the user-specified threshold, adaptively refining a current mesh of the physical simulation solver and continuing execution of the physical simulation solver.
